(19) United States
(12) Patent Application Publication
(10) Pub. No.: US 2023/0147717 A1
(43) Pub. Date: May 11, 2023

(54) Rear Wheel for a Powered Two-Wheeler

(71) Applicant: Ronny Koelbl, Goeppingen (DE)

(72) Inventor: Ronny Koelbl, Goeppingen (DE)

(21) Appl. No.: 17/907,832

(22) PCT Filed: Mar. 9, 2021
(86) PCT No.: PCT/EP2021/055880

§ 371 Date: Aug. 29, 2022

(30) Foreign Application Priority Data
Mar. 11, 2020 (DE) 10 2020 106 581.7

(51) Int. Cl. B60B 27/00; B60B 25/02

(52) U.S. Cl. CPC B60B 27/0052; B60B 27/0015; B60B 25/02; B60Y 2200/12

(57) ABSTRACT

A rear wheel (1) for a powered two-wheeler has a hub (3), a rim (4) which has a rim well (5) and two rim flanges (6) terminating the rim (4) on both sides, at least one connecting element (7) for connecting the hub (3) to the rim (4), an interface (8) for attaching the rear wheel (1) to the two-wheeler, and receptacles (9, 10) provided on both sides of the rear wheel (1) for receiving a brake disc (11) and/or a drive element (12) serving to rotate the rear wheel (1). The receptacles (9, 10) on both sides are identical to one another.

The invention relates to a rear wheel for a powered two-wheeler, having a hub, a rim which has a rim well and two rim flanges terminating the rim on both sides, at least one connecting element for connecting the hub to the rim, an interface for attaching the rear wheel to the two-wheeler, and receptacles provided on both sides of the rear wheel for receiving a brake disc and/or a drive element serving to rotate the rear wheel. Furthermore, the invention relates to a rear wheel for a powered two-wheeler according to the preamble of claims 5 and 7.

Such rear wheels are known from the general prior art. In some cases, these rear wheels are also referred to as “rear wheel rims”, the term “rim” in itself referring only to the outer part of the wheel on which the tire rests.

A rear swingarm for a powered two-wheeler with such a rear wheel mounted in the rear swingarm is described, for example, in EP 2 617 634 B1.

When powered two-wheelers, for example motorcycles or mopeds, are driven on “normal” roads, such as state or federal highways, there is usually uniform wear of the tire over its entire surface and in particular on both flanks. However, this is often not the case when driving on a race track, because on many race tracks the number of righthand bends does not correspond to the number of left-hand bends. For example, there are nine right-hand corners and six left-hand corners on the Mugello racetrack. A similar constellation is also found at the circuits in Jerez, Barcelona and Brno, whereas at Imola and Valencia, for example, the number of left-hand corners is higher than the number of right-hand corners.

This leads to uneven wear of the tires, as a result of which after a certain time they are worn down on one half or flank, while they can still be used on the other side or flank. Since racing motorcycles use much softer tire compounds that are subject to greater wear than standard motorcycles, this uneven wear of the two tire halves is often noticeable after a relatively short time.

In professional racing, this does not play a major role because, from a financial point of view, the racing teams can usually afford to dispose of tires that are worn on one side but could still be used on the other.

However, for amateur racers, who often use their personal assets to be able to race to a certain extent, this is seen as a waste. Therefore, many amateur racers change the tire worn on one half on the wheel so that the previously left side is on the right side and vice versa. This can sometimes significantly extend the life of the tire.

The disadvantage of this procedure is that it is very time-consuming, as the tire must be removed from the wheel or rim and then remounted. This takes up a lot of time, which the racers would like to use differently. In addition, this requires a tire changer, which has to be brought to the race track at a corresponding expense, or the use of which often results in additional costs.

Another problem of the known rear wheels of two-wheelers is that all two-wheeler manufacturers use different designs of brake discs and drive elements as well as the carrier elements that accommodate these components. This means that rear wheel manufacturers have to produce a very large number of different wheels, which increases the cost of the wheels. Frequently, this variety of different components is the case not only from manufacturer to manufacturer, but also from model to model of one and the same manufacturer.

It is therefore an object of the present invention to provide a rear wheel for a powered two-wheeler which permits, in a simple manner, use of the tire mounted thereon on both sides.

According to the invention, this object is solved by the features mentioned in claim 1.

Due to the identical design of the receptacles for receiving the brake disc on the one hand and for receiving the drive element on the other hand, it is possible in a very simple manner to exchange the position of the brake disc with the position of the drive element after dismounting the rear wheel from the swingarm receiving the same, whereby the rear wheel can be rotated by 180° and can be remounted on the swingarm in this 180° rotated position.

This simple 180° rotation of the rear wheel, in which only the drive element and the brake disc are dismounted and remounted on the opposite side, also rotates the tire mounted on it by 180°, so that the left half of the tire is now on the right side of the wheel and vice versa. In this way, the half or sidewall of the tire that is less worn ends up on the side of the wheel that is subject to greater wear during subsequent use. As a result, the tire can be driven for a longer period of time or over a longer distance and only needs to be disposed of when it is completely worn out. This results in a very high cost saving for the driver of the two-wheeler equipped with the rear wheel according to the invention.

A particular advantage of the solution according to the invention is that it is simple to implement, since only the wheel has to be dismantled, the brake disc replaced with the drive element, e.g. a sprocket, and the wheel then remounted. Thus, no tire mounting machine is required and it is no longer necessary to dismount the tire from the wheel or rim and then remount it. Rather, the result is a greatly simplified “tire change” compared to the previous procedure, in which the tire itself is not changed at all.

Furthermore, it can be provided that one of the receptacles is designed to receive a carrier element of the brake disc and the other receptacle is designed to receive a carrier element of the drive element. Such an embodiment is particularly suitable for use in conventional rear swingarms, so-called double-sided swingarms. The term “double-sided swingarms” covers all swingarms that have two arms between which the rear wheel is mounted.

Alternatively, it can be provided that the two receptacles are each designed for an assembly unit comprising the brake disc and the drive element. This embodiment is particularly suitable for use with single-sided swingarms in which the drive element and the brake disc are on the same side.

In this context, a further advantageous embodiment of the invention can be that the assembly unit comprising the brake disc and the drive element is arranged in one of the receptacles and a cover element covering the receptacle is arranged in the other receptacle. Such a design allows particularly good adaptation to the conditions of a single-sided swingarm.

An alternative solution to the problem is given in claim 5.

This alternative solution is specially designed for single-sided swingarms, in which it is then only necessary to detach the rim from the connecting element connecting the hub to the rim by means of the connecting devices and then to remount it on the connecting element in a position rotated by 180° by means of the connecting devices.

Also in this way, with very little effort, the tire mounted on the rear wheel is rotated by 180° so that the left half of the tire is on the right side of the wheel and vice versa, and the half of the tire that is less worn goes to the side of the wheel that is subject to greater wear, ultimately obtaining the same advantages as explained above.

This alternative solution can also be carried out in a very simple way, so that again no tire mounting machine is required and it is not necessary to dismount the tire from the wheel or rim and then remount it.

In a very advantageous further development of this alternative embodiment, it may be provided that the connecting devices for connecting the rim to the connecting element have respective threaded bores and screws engaging in the threaded bores. This results in a very simple assembly and disassembly of the rim from the connecting element connecting the hub to the rim.

A further alternative solution to the problem is given in claim 7.

Due to the fact that both the support element for the brake disc and the support element for the drive element are designed independently of the hub and thus of the essential components of the rear wheel, the remaining components of the rear wheel, namely the hub, the rim with the rim well and the rim flanges, the at least one connecting element, the interface for attaching the rear wheel to the two-wheeler and the receptacles for one and the same rim size can always be designed identically and independently of the special attachment parts of the respective two-wheeler manufacturer, and it is only necessary to adapt the two carrier elements to the respective requirements of the manufacturer. As a result, the production of the rear wheel according to the invention can be significantly simplified, resulting in considerable cost advantages over known solutions.

In a very advantageous further development of the invention, it can be provided that the carrier element for the brake disc and the carrier element for the drive element are detachably connected to the hub via the receptacles. In this way, the advantages mentioned above with reference to the alternative solutions to the object, namely a rapid remounting of the rear wheel within the swingarm of the two-wheeler and thereby a simplified “tire change” compared to the previous procedure, in which the tire itself is not changed at all, can be realized.

In order to enable particularly simple and thus very cost-effective manufacture of the rear wheel according to the invention, it can also be provided that the rear wheel is formed as a one-piece component with the hub, the rim, the rim well, the rim flanges, the at least one connecting element, the interface and the receptacles.

The possibility to rotate the rear wheel by 180° in the swingarm receiving the same is simplified, if the rear wheel with the hub, the rim, the rim well, the rim flanges, the at least one connecting element, the interface and the receptacles is formed symmetrically with respect to a plane arranged perpendicular to an axis of rotation of the rear wheel.

In the following, embodiments of the invention are illustrated in principle with reference to the drawing.

In the drawing:

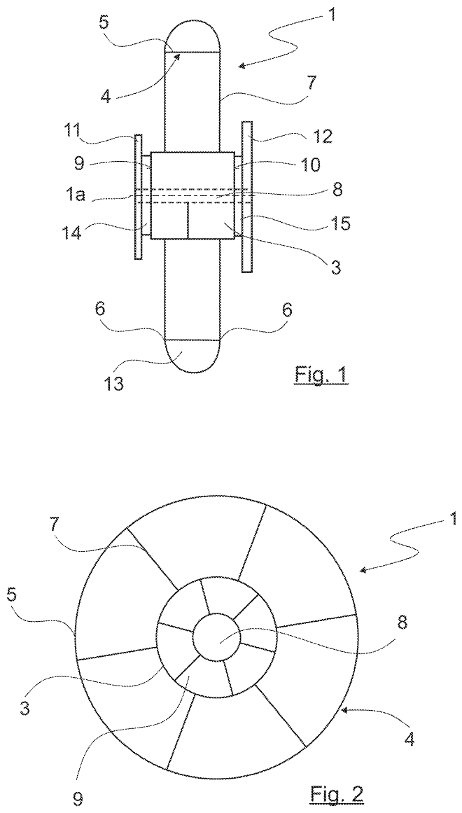

FIG. 1 shows a first embodiment of a rear wheel according to the invention;

FIG. 2 shows a view of a receptacle of the rear wheel of FIG. 1;

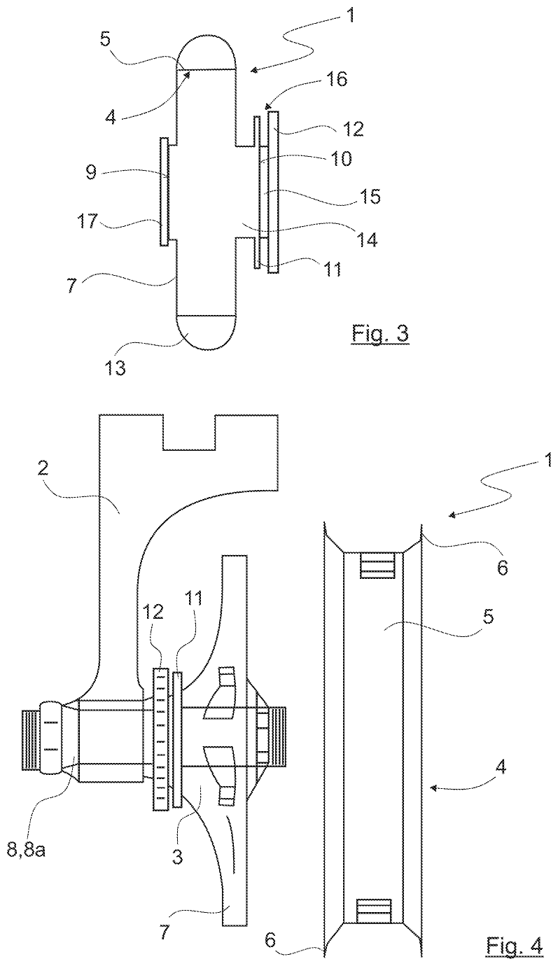

FIG. 3 shows a second embodiment of a rear wheel according to the invention;

FIG. 4 shows a third embodiment of a rear wheel according to the invention;

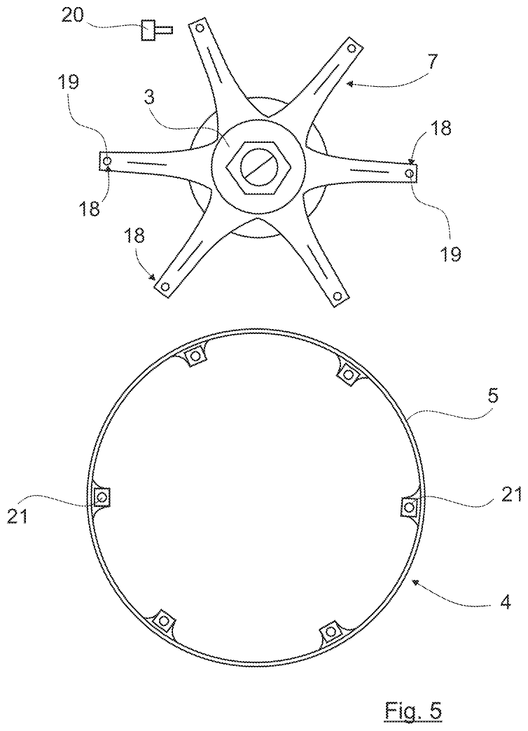

FIG. 5 shows a view of the rear wheel according to arrow V of FIG. 4 in its disassembled state;

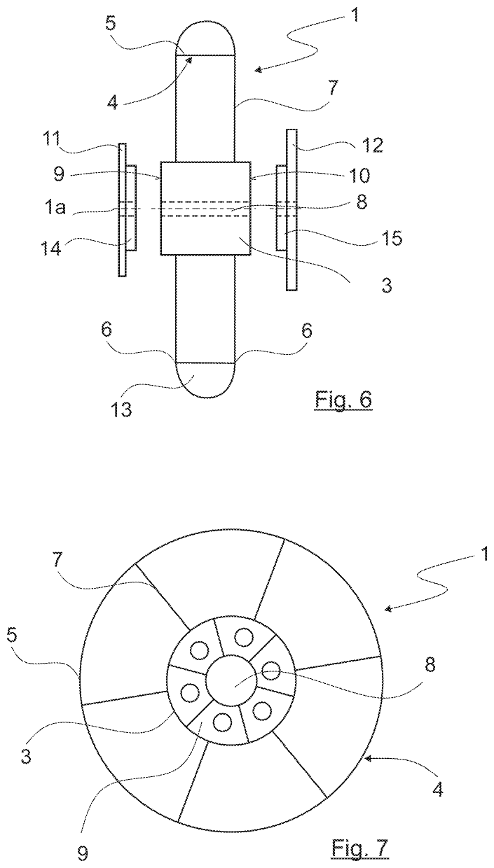

FIG. 6 shows a further embodiment of a rear wheel according to the invention;

FIG. 7 shows a view according to arrow VII from FIG. 6.

FIGS. 1 and 2 show a schematic representation of a rear wheel 1 for a powered two-wheeler which is not shown in the drawing. Only a rear swingarm 2 of the powered two-wheeler is shown in FIG. 4, which in the embodiment of FIG. 4 is designed as a single-sided swingarm.

In a manner known per se, the rear wheel 1 has a hub 3, a rim 4 which has a rim well 5 and two rim flanges 6 terminating the rim 4 on both sides, a connecting element 7 for connecting the hub 3 to the rim 4, an interface 8 indicated by a broken line for attaching the rear wheel 1 to the powered two-wheeler, and receptacles 9 and 10 provided on both sides of the rear wheel 1. The first receptacle 9, shown in the present case on the left-hand side, is for receiving a brake disc 11, and the second receptacle 10, shown on the right-hand side of the rear wheel 1, is for receiving a drive element 12 serving to rotate the rear wheel 1. The drive element 12 in the present case is a chain wheel, it is, however, also possible to use a pulley or the like as the drive element 12.

For its connection to the rim 4, the hub 3 is firmly connected to the connecting element 7 or is made in one piece with the connecting element 7. The connecting element 7 is also preferably made in one piece with the rim 4. The connecting element 7 can have a plurality of spokes in a manner known per se, as shown for example in FIG. 5.

In the present case, the interface 8 for attaching the rear wheel 1 to the two-wheeler is designed as a bore running through the hub 3, through which an axle 8a shown in FIG. 4 is inserted in a manner known per se, which is screwed onto both sides of the swingarm 2. Of course, other possibilities for fixing the axle to the swingarm 2 are also conceivable.

In order to be able to mount the rear wheel 1 on the swingarm 2 in the position shown, but also in a position rotated by 180°, the receptacles 9 and 10 are identical to one another in terms of their transverse section on their side facing the brake disc 11 or the drive element 12 on both sides of the rear wheel 1. This makes it possible to mount the brake disc 11 not only in the receptacle 9 provided for this purpose per se, but also in the receptacle 10. Conversely, it is also possible to mount the drive element 12 not only in the receptacle 10 provided for this purpose per se, but also in the receptacle 9. This allows the rear wheel 1 to be easily rotated within the swingarm 2, whereby a tire 13 mounted on the rear wheel 1 is positioned after rotation such that the flank of the tire 13 previously located on the right side of the rear wheel 1 is located on the left side after rotation and vice versa. Thus, if the tire 13 is worn on one side due to its previous use, it can be used again. In this subsequent use, the previously less worn flank of the tire 13 is then exposed to a higher degree of wear. Although this also changes the running direction of the tire 13, this does not cause any problems when using suitable tires 13.

Both the brake disc 11 and the drive element 12 are mounted on respective carrier elements 14 and 15, which are arranged or accommodated in the receptacles 9 and 10, respectively. Due to the identical design of the receptacles 9 and 10 described above, the carrier elements 14 and 15 can be arranged both in the receptacle 9 and in the receptacle 10. However, due to the different design of the brake disc 11 and the drive element 12, the carrier element 14 is adapted to the brake disc 11 on the side opposite the receptacle 9 or 10 and the carrier element 15 is adapted to the drive element 12 on the side opposite the receptacle 9 or 10. The carrier element 14 can be firmly connected to the brake disk 11 and/or the carrier element 15 can be firmly connected to the drive element 12. On the side facing the receptacle 9 or 10, however, the carrier elements 14 and 15 are designed identically to one another. A positive connection or form-locked join between the receptacles 9 and 10 on the one hand and the carrier elements 14 and 15 on the other is preferable. Shock absorbers or similar damping elements are arranged between the receptacles 9 and 10 on the one hand and the carrier elements 14 and 15 on the other hand in order to minimize wear of the receptacles 9 and 10 and the carrier elements 14 and 15.

The hub 3 may be formed such that a respective outer edge of the hub 3 on both sides, which has a maximum distance from a plane passing through the axis of rotation 1a of the rear wheel 1, has the same distance from the plane on both sides of the hub 3. In other words, the two outer edges or the respective planar surfaces of the hub 3 are each equidistant from the center of the rear wheel 1. In this way, it is ensured that in both positions in which the rear wheel 1 can be mounted within the swingarm 2, the rear wheel 1 is always in the center of the swingarm 2. The carrier elements 14 and 15 can also be used to compensate for any dimensional differences between the left and right sides of the rear wheel 1 by selecting their extension in the axial direction so that the correct axial distance from the center of the rear wheel 1 is established for these two components when the brake disc 11 is exchanged with the drive element 12.

Preferably, the rear wheel 1 with the hub 3, the rim 4, the rim well 5, the rim flanges 6, the at least one connecting element 7, the interface 8 and the receptacles 9, 10 is formed symmetrically with respect to a plane arranged perpendicular to the axis of rotation 1a, in the present case the center plane of the rear wheel 1. The rear wheel 1 with the hub 3, the rim 4, the rim well 5, the rim flanges 6, the at least one connecting element 7, the interface 8 and the receptacles 9, 10 can be formed as a one-piece component. For example, the rear wheel 1 can be manufactured by forging or casting.

In FIG. 2, the rear wheel 1 is shown in a plan view, in which one of the receptacles, in the present case receptacle 9, which serves to receive the carrier element 14 of the brake disc 11, can be seen very schematically. As explained above, the receptacle 10 located on the other side of the rear wheel 1 is identical in design to the receptacle 9. The illustrated design of the receptacle 9 is to be regarded as purely exemplary and completely different designs of the receptacle 9 and the receptacle 10 are conceivable. In particular, the way in which the receptacles 9 and 10 are designed depends on the respective design of the powered two-wheeler in this area. However, the two carrier elements 14 and 15 can also be designed as a type of adapter and adapted to the respective conditions of the powered two-wheeler in this area. The carrier elements 14 and 15 are not shown in FIG. 2, but it is very easy for the person skilled in the art to understand how they must be designed in order to be adapted to the receptacles 9 or 10. As already mentioned, a wide variety of designs are conceivable.

FIG. 3 shows an alternative embodiment of the rear wheel 1, which in this case is designed for a single-sided swingarm. The two receptacles 9 and 10 are each designed for a assembly unit 16, which is formed by the brake disc 11 and the drive element 12. In one of the receptacles 9 or 10, in the present case in receptacle 10, the assembly unit 16 comprising the brake disk 11 and the drive element 12 is arranged, and in the other receptacle 9 a cover element 17 covering the receptacle 10 is arranged. The cover element 17 can be provided with projections corresponding to the projections of the assembly unit 16 in order to achieve an adaptation to the receptacles 9 and 10. Alternatively or additionally, the cover element 17 may be or comprise a fastening element, such as a screw or nut.

FIGS. 4 and 5 show another embodiment of the rear wheel 1 for the powered two-wheeler. The rear wheel 1 again has the hub 3, the rim 4, which in turn has the rim well 5 and the two rim flanges 6 terminating the rim 4 on both sides, the connecting element 7 for connecting the hub 3 to the rim 4, and the interface 8 for attaching the rear wheel 1 to the two-wheeler, i.e. to the rear swingarm 2. In this embodiment, however, the brake disc 11 and the drive element 12 are connected to the hub 3, which in turn is fixedly connected to the connecting element 7 for connecting the hub 3 to the rim 4.

In order to be able to rotate the tire 13 by 180° without considerable effort in this embodiment as well, the rim 4 is detachably connected to the connecting element 7 via respective connecting devices 18, as shown in FIG. 5. In order to be able to connect the rim 4 to the connecting element 7 both in the position shown and in the position rotated by 180°, the connecting devices 18 are formed identically to one another on both sides of the rim 4. Thereby, the rim 4 can be separated from the connecting element 7 and thus from the hub 3 by releasing the connecting devices 18, rotated by 180° and then mounted in the reverse manner on the swingarm 2, which is also designed as a single-sided swingarm in this embodiment. FIG. 5 shows the state in which the rim 4 is detached from the hub 3 and can be rotated. Again, this allows the above-described rotation of the tire 13 in order to interchange its flanks and without having to disassemble it from the rear wheel 1.

In this case, the connecting devices 18 for connecting the rim 4 to the connecting element 7 have threaded holes 19 associated with or provided in the respective connecting element 7, screws 20 engaging in the threaded holes 19 and indicated only schematically, and respective through holes 21 associated with or provided in the rim 4, through which the screws 20 are inserted.

In this respect, it is irrelevant whether the connecting devices 18 for connecting the rim 4 to the connecting element 7 are arranged in the center or on an outer side of the rim well 5, viewed in the direction of the width of the rim 4.

The embodiment illustrated in FIGS. 4 and 5 is also suitable for use with a cardan drive. In this case, the rear wheel 1 would be constructed similarly to the single-sided swingarm shown. However, the drive unit would not be arranged like the drive element 12 designed as a chain wheel in FIG. 4, but would run outside the swingarm, so that the hub 3 would move further into the center. Furthermore, such an embodiment is also suitable for single-sided swingarms in which the drive element 12 designed as a chain wheel is arranged outside the swingarm and the brake disc 11 is arranged inside the swingarm.

FIGS. 6 and 7 show a further embodiment of the rear wheel 1. Here, both the carrier element 14 for the brake disc 11 and the carrier element 15 for the drive element 12 are designed as components independent of the hub 3. In FIG. 6, the two carrier elements 14 and 15 are shown at a certain distance from the hub 3 of the rear wheel 1.

Preferably, the carrier element 14 for the brake disc 11 and the carrier element 15 for the drive element 12 are detachably connected to the hub 3 via the receptacles 9 or 10. As a result, the carrier elements 14 and 15 can be detached from the remaining components of the rear wheel 1 and the rear wheel 1 can be rotated by 180°, similarly as described with reference to the above embodiments. For example, a connection of the carrier element 14 for the brake disc 11 via the receptacle 9 to the hub 3 can be made via screws or the like. However, it is also possible to connect the carrier element 14 firmly or non-detachably to the hub 3, for example by means of welding. The carrier element 15 for the drive element 12 is preferably connected to the receptacle 10 and thus to the hub 3 via shock absorbers or the like.

In the illustration of FIG. 6, the brake disc 11 is shown as connected to the carrier element 14. Similarly, the drive element 12 is also shown as connected to the carrier element 15. The connection of the brake disc 11 to the carrier element 14 and the connection of the drive element 12 to the carrier element 15 can be performed in a manner known per se.

The rear wheel 1 with the hub 3, the rim 4, the rim well 5, the rim flanges 6, the at least one connecting element 7, the interface 8 and the receptacles 9, 10 can be formed as a one-piece component. For example, the rear wheel 1 can be manufactured by forging or casting. Furthermore, the rear wheel 1 with the hub 3, the rim 4, the rim well 5, the rim flanges 6, the at least one connecting element 7, the interface 8 and the receptacles 9, 10 can be formed symmetrically with respect to a plane arranged perpendicular to the axis of rotation 1a, in the present case the center plane of the rear wheel 1.

1: A rear wheel for a powered two-wheeler, having a hub, a rim which has a rim well and two rim flanges terminating the rim on both sides, at least one connecting element for connecting the hub to the rim, an interface for attaching the rear wheel (1) to the two-wheeler, and receptacles comprised of a first receptacle and a second receptacle provided on both sides of the rear wheel for receiving a brake disc and/or a drive element serving to rotate the rear wheel, the receptacles on both sides being identical to one another.

2: The rear wheel according to claim 1, wherein the first receptacle is designed to receive a carrier element of the brake disc and the second receptacle is designed to receive a carrier element of the drive element.

3: The rear wheel according to claim 1, wherein the receptacles are each designed for an assembly unit comprising the brake disc and the drive element.

4: The rear wheel according to claim 3, wherein the assembly unit comprising the brake disc and the drive element is arranged in the first receptacles (9) and a cover element covering the second receptacle is arranged in the second receptacle.

5: The rear wheel for a powered two-wheeler, having a hub, a rim which has a rim well and two rim flanges terminating the rim on both sides, at least one connecting element for connecting the hub to the rim, and an interface for attaching the rear wheel to the two-wheeler, the rim being detachably connected to the connecting element via respective connecting devices, the connecting devices being designed identically to one another on both sides of the rim.

6: The rear wheel according to claim 5, wherein the connecting devices for connecting the rim to the connecting element have respective threaded bores and screws engaging in the threaded bores.

7: The rear wheel for a powered two-wheeler, having a hub, a rim which has a rim well and two rim flanges terminating the rim on both sides, at least one connecting element for connecting the hub to the rim, an interface for attaching the rear wheel to the two-wheeler, receptacles provided on both sides of the rear wheel for receiving a brake disc and/or a drive element serving to rotate the rear wheel, a carrier element for the brake disc and a carrier element for the drive element, wherein both the carrier element for the brake disc and the carrier element for the drive element are designed as components independent of the hub.

8: The rear wheel according to claim 7, wherein the carrier element for the brake disk and the carrier element for the drive element are detachably connected to the hub via the receptacles.

9: The rear wheel according to claim 7, wherein the rear wheel is formed as a one-piece component with the hub, the rim, the rim well, the rim flanges, the at least one connecting element, the interface and the receptacles.

10: The rear wheel according to claim 7, wherein the rear wheel with the hub, the rim, the rim well, the rim flanges, the at least one connecting element, the interface and the receptacles are formed symmetrically with respect to a plane arranged perpendicular to an axis of rotation of the rear wheel.

11: The rear wheel according to claim 8, wherein the rea wheel is formed as a one-piece component with the hub, the rim, the rim well, the rim flanges, the at least one connecting element, the interface and the receptacles.

12: The rear wheel according to claim 8, wherein the rear wheel with the hub, the rim the rim well, the rim flanges, the at least one connecting element, the interface and the receptacles are form symmetrically with respect to a plane arranged perpendicular to an axis of rotation of the rear wheel.

13: the rear wheel according to claim 9, wherein the rear wheel with the hub, the rim, the rim well, the rim flanges, the at least one connecting element, the interface and the receptacles are formed symmetrically with respect to a plane arrange perpendicular to an axis of rotation of the rear wheel.
